(19) United States
(12) Patent Application Publication
(10) Pub. No.: US 2017/0063758 A1
(43) Pub. Date: Mar. 2, 2017

(54) METHOD, DEVICE, TERMINAL, AND ROUTER FOR SENDING MESSAGE

(71) Applicant: Xiaomi Inc., Beijing (CN)

(72) Inventors: Yi GAO, Beijing (CN); Hongqiang WANG, Beijing (CN); Yunyuan GE, Beijing (CN)

(73) Assignee: Xiaomi Inc.

(21) Appl. No.: 15/222,248

(22) Filed: Jul. 28, 2016

(30) Foreign Application Priority Data
Aug. 31, 2015 (CN) 201510549221.9

(51) Int. Cl. H04L 12/58; H04M 1/725

(52) U.S. Cl. CPC H04L 51/14; H04L 51/38; H04L 51/34; H04M 1/72527; H04M 2250/22

(57) ABSTRACT

A method for sending a message includes receiving the message by a first smart device, determining whether the first smart device is in a user operation state, identifying a second smart device that is in the user operation state if the first smart device is not in the user operation state, and forwarding the message to the second smart device.

### CROSS-REFERENCE TO RELATED APPLICATIONS

The present application is based upon and claims priority to Chinese Patent Application No. 201510549221.9 filed Aug. 31, 2015, the entire contents of which are incorporated herein by reference.

### TECHNICAL FIELD

The present disclosure generally relates to network communication technology and, more particularly, to a method, device, terminal, and router for sending a message.

### BACKGROUND

With the development and popularization of smart devices, a user may possess more than one smart device, such as a smart mobile phone, a wearable device, and a tablet computer, and the like. Using these smart devices, the user can receive and send messages, run applications (APP), and the like. It is possible that more than one smart device can receive messages, notifications, and the like.

### SUMMARY

In accordance with the present disclosure, there is provided a method for sending a message including receiving the message by a first smart device, determining whether the first smart device is in a user operation state, identifying a second smart device that is in the user operation state if the first smart device is not in the user operation state, and forwarding the message to the second smart device.

Also in accordance with the present disclosure, there is provided a method for sending a message including establishing connections with smart devices, receiving a request from a requesting smart device for identifying an active smart device that is in a user operation state, acquiring information about the active smart device, and returning the information to the requesting smart device.

Also in accordance with the present disclosure, there is provided a terminal including a processor and a memory storing instructions. The instructions, when executed by the processor, cause the processor to receive a message, determine whether the terminal is in a user operation state, identify another terminal that is in the user operation state if the terminal is not in the user operation state, and forward the message to the other terminal.

Also in accordance with the present disclosure, there is provided a router including a processor and a memory storing instructions. The instructions, when executed by the processor, cause the processor to establish connections with smart devices, receive a request from a requesting smart device for identifying an active smart device that is in a user operation state, acquire information about the active smart device, and return the information to the requesting smart device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for sending a message according to an exemplary embodiment of the present disclosure.

FIG. 2 is a flow chart illustrating a method for sending a message according to another exemplary embodiment of the present disclosure.

FIG. 3 is a flow chart illustrating a method for sending a message according to another exemplary embodiment of the present disclosure.

FIG. 4 is a flow chart illustrating a method for sending a message according to another exemplary embodiment of the present disclosure.

FIG. 5 is a schematic diagram illustrating an application scenario for sending a message according to an exemplary embodiment of the present disclosure.

FIG. 6 is a block diagram of a device for sending a message according to an exemplary embodiment of the present disclosure.

FIG. 7 is a block diagram of an example of a determining module in the device shown in FIG. 6.

FIG. 8 is a block diagram of another example of the determining module.

FIG. 9 is a block diagram of another example of the determining module.

FIG. 10 is a block diagram of another example of the determining module.

FIG. 11 is a block diagram of an example of a first message forwarding module in the device shown in FIG. 6.

FIG. 12 is a block diagram of a device for sending a message according to another exemplary embodiment of the present disclosure.

FIG. 13 is a block diagram of a device for sending a message according to another exemplary embodiment of the present disclosure.

FIG. 14 is a block diagram of a device for sending a message according to another exemplary embodiment of the present disclosure.

FIG. 15 is a block diagram of a device for sending a message according to another exemplary embodiment of the present disclosure.

FIG. 16 is a block diagram of a device for sending a message according to another exemplary embodiment of the present disclosure.

FIG. 17 is a block diagram of a device for sending a message according to another exemplary embodiment of the present disclosure.

FIG. 18 is a block diagram of a device for sending a message according to another exemplary embodiment of the present disclosure.

FIG. 19 is a block diagram of an example of a connection establishing module in the device shown in FIG. 15.

FIG. 20 is a block diagram of another example of the connection establishing module.

FIG. 21 is a block diagram of an example of a device-information acquiring module in the device shown in FIG. 15.

FIG. 22 is a block diagram of a device for sending a message according to another exemplary embodiment of the present disclosure.

FIG. 23 is a block diagram of a device for sending a message according to another exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used herein are merely for describing a particular embodiment, rather than limiting the present disclosure. As used in the present disclosure and the appended claims, terms in singular forms such as “a”, “said”, and “the” are intended to also include plural forms, unless explicitly represented otherwise. It should also be understood that the term “and/or” used herein means any one or any possible combination of one or more associated listed items.

It should be understood that, although an element may be described with a term first, second, or third, etc., the element is not limited by the term used. The terms first, second, third, and etc. are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where”, or “in response to”.

Methods consistent with the present disclosure can be implemented, for example, in a smart device and/or a control device. The smart device can be, for example, a terminal, a wearable device, or a smart household appliance. The terminal can be any smart terminal having a network access capability. For example, the terminal can be a mobile phone, a tablet computer, a Personal Digital Assistant (PDA), or the like. The wearable device can be a smart watch, a smart bracelet, smart glasses, etc. The smart household appliance can be a smart television, a smart air conditioner, etc. The smart device can be connected to a router through a Wireless Fidelity (Wi-Fi) network, can access a server over a public network through the router, and can communicate with other smart devices through the router. In the present disclosure, the router is a smart router, which not only has conventional router features, but also further includes an independent operating system and a magnetic disc. The magnetic disc can have a suitable storage size, for example, 1T. The control device is a device connected to smart devices for managing operation states of the smart devices. For example, the control device is a router.

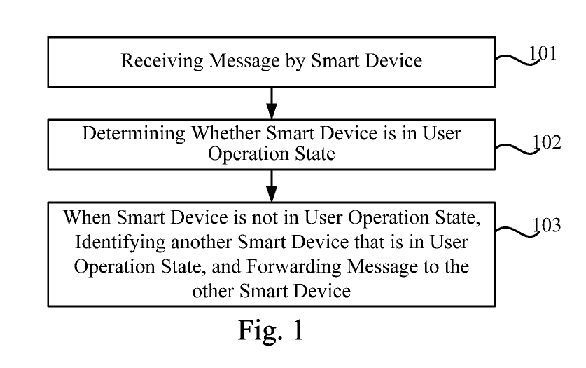

FIG. 1 is a flow chart illustrating a method for sending a message according to an exemplary embodiment. As shown in FIG. 1, at 101, a message is received by a smart device. At 102, it is determined whether the smart device is being used by a user. At 103, if the smart device is not being used by the user, another smart device that is being used by the user is identified, and the message is forwarded to the other smart device.

That is, the smart device that receives the message is not necessarily a smart device that is being used by the user. Hereinafter, a smart device that is being used by a user is also referred to as a smart device in a user operation state. For example, when a smart mobile phone of the user receives a short message, the smart mobile phone may be on a table, while the user is currently on a couch watching TV and cannot hear the notification sound of the mobile phone on the table. In this case, the smart TV is a smart device that is in the user operation state. Thus, the mobile phone forwards the message to the smart TV to timely notify the user of the received new message.

In the present disclosure, when the smart device which receives the message is not in the user operation state, the device which is in the user operation state is identified, and the received message is sent to the smart device which is in the user operation state. Thereby, it can timely notify the user of receiving a new message, facilitate the user to timely check the new message, and can avoid missing an important message. This can bring convenience to the user and improve user experience.

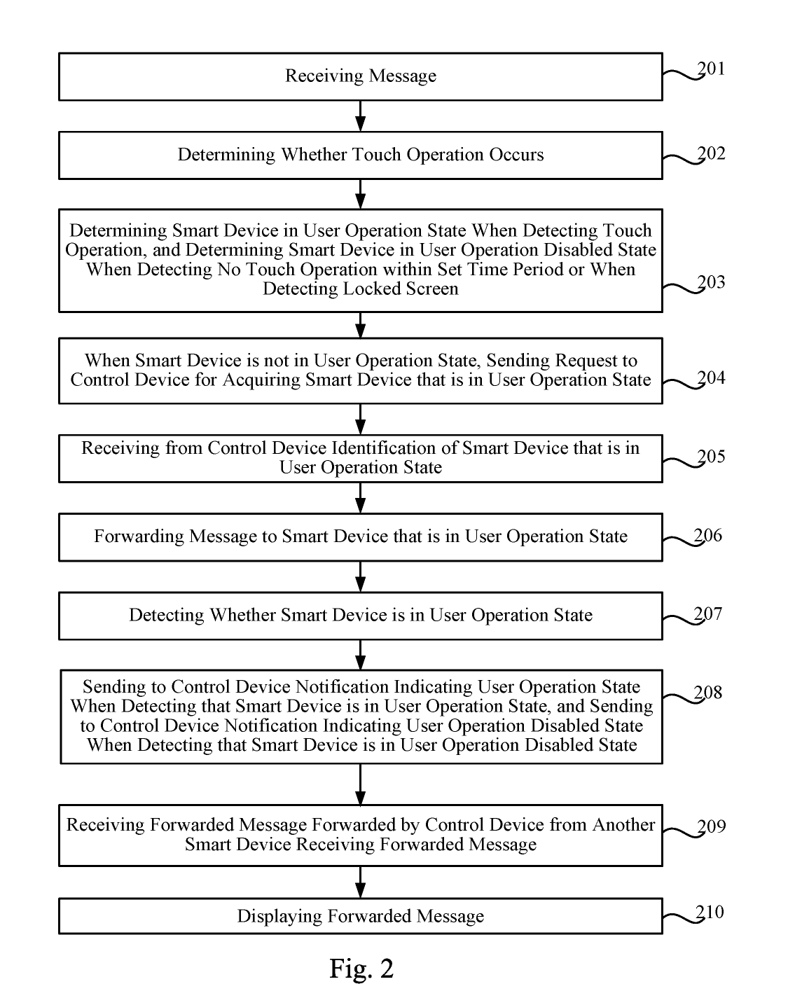

FIG. 2 is a flow chart illustrating a method for sending a message according to another exemplary embodiment. As shown in FIG. 2, at 201, a message is received by a smart device. In some embodiments, the smart device can be a smart mobile phone, and the message received by the smart mobile phone can include an incoming call, a short message, a social network message, an instant message, a notification pushed by an application, or the like. In other embodiments, the smart device can also be, for example, a tablet computer.

At 202, it is determined whether a touch operation on the smart device occurs. The touch operation can be, for example, a touch with respect to the screen, or a grasp with respect to another part of the smart device.

At 203, when a touch operation is detected, it is determined that the smart device is in the user operation state. On the other hand, when no touch operation is detected within a set time period, or when a locked screen is detected, it is determined that the smart device is not in the user operation state. Hereinafter, a smart device not in the user operation state is also referred to as a smart device in a user operation disabled state. The set time period can be several seconds to dozens of seconds, for example.

In some embodiments, determining whether the smart device that receives the message is in the user operation state can also be implemented through other manners. For example, if the smart device is a wearable device, such as smart glasses or a smart bracelet, the smart device can also determine whether a putting-on operation or whether a taking-off operation of the smart device is detected. When the putting-on operation is detected, it is determined that the smart device is in the user operation state. When the taking-off operation is detected, it is determined that the smart device is in the user operation disabled state.

If the smart device has a front camera, the smart device can acquire a front image through the front camera, and determine whether a user face image is detected in the front image using a face recognition technique. When the user face image is detected, it is determined that the smart device is in the user operation state. When no user face image is detected, it is determined that the smart device is in the user operation disabled state.

In some embodiments, if the smart device cannot determine the current operation state, the smart device can send a request to a control device for acquiring a smart device that is in the user operation state. Then, the smart device receives from the control device an identification of a smart device that is in the user operation state, and determines whether the received identification corresponds to the identification of the smart device. When the received identification corresponds to the identification of the smart device, it is determined that the smart device is in the user operation state. When the received identification does not correspond to the identification of the smart device, it is determined that the smart device is in the user operation disabled state.

At 204, if the smart device is not in the user operation state, i.e., if the smart device is in the user operation disabled state, a request is sent to the control device for acquiring a smart device that is in the user operation state. The control device stores identifications of smart devices and their corresponding states, including the user operation state and the user operation disabled state.

At 205, an identification of a smart device that is in the user operation state is received from the control device.

At 206, the message is forwarded to the smart device that is in the user operation state, based on the identification returned by the control device.

In some embodiments, as shown in FIG. 2, at 207, it is detected whether the smart device is in the user operation state. At 208, a notification indicating the user operation state is sent to the control device if it is detected that the smart device is in the user operation state, and a notification indicating the user operation disabled state is sent to the control device if it is detected that the smart device is in the user operation disabled state. The notification can include the identification of the smart device, such that the control device can mark a stored state corresponding to the identification accordingly. The smart device is detected to be in the user operation state if, for example, a touch operation or a putting-on operation is detected, or a user face image in a front image captured by a front camera is detected using a face recognition technique. On the other hand, the smart device is detected to be in the user operation disabled state if, for example, no touch operation is detected within a preset time period, a locked screen is detected, a taking-off operation is detected, or no user face image in the front image captured by the front camera within a preset time period is detected.

With the above-described processes 207 and 208, the control device can be timely informed of the states of the smart devices, such that the control device can timely modify the state records of the smart devices. Thus, which smart device is in the user operation state can be accurately and timely determined.

The above processes 207 and 208 are not necessarily performed after processes 201-206. Rather, the processes 207 and 208 can be performed at any time after the smart device establishes a connection with the control device.

In some embodiments, as shown in FIG. 2, at 209, a forwarded message is received when the smart device is in the user operation state. The forwarded message is forwarded by the control device from another smart device that receives the forwarded message. At 210, the received forwarded message is displayed. For example, if the smart device in the user operation state is a television or a computer, the forwarded message can be displayed on a screen of the television or the computer. If the smart device in the user operation state is smart glasses, the message is displayed on the lenses. According to the present disclosure, the processes 209 and 210 are not necessarily performed after processes 201-208.

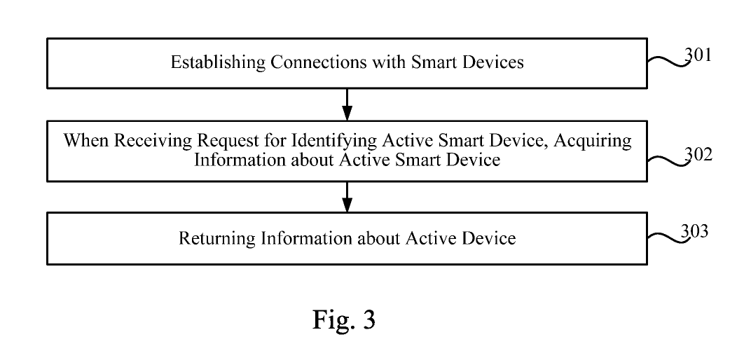

FIG. 3 is a flow chart illustrating a method for sending a message according to another exemplary embodiment, which can be implemented, for example, in a control device. As shown in FIG. 3, at 301, connections are established with smart devices. Thus, the control device is connected to the smart devices for managing operation states of the smart devices. At 302, when a request for identifying a smart device that is in the user operation state is received, information about the smart device in the user operation state is acquired. Consistent with the present disclosure, the control device stores identifications of the smart devices connected with the control device and their corresponding states, including the user operation state and the user operation disabled state. Hereinafter, a smart device in the user operation state is also referred to as an active smart device and a smart device in the user operation disabled state is also referred to as an inactive smart device. At 303, the information about the active smart device is returned. In some embodiments, the information about the active smart device can be a device identification of the active smart device.

In some embodiments, the control device can store the state of a smart device based on a received notification indicating the operation state of the smart device. For example, when the notification indicates the smart device is in the user operation state, the state corresponding to the smart device is stored as being in the user operation sate. On the other hand, when the notification indicates the smart device is in the user operation disabled state, the state corresponding to the smart device is stored as being in the user operation disabled state. As such, the control device can timely modify the stored states of the smart devices, and can accurately determine which smart device is an active smart device.

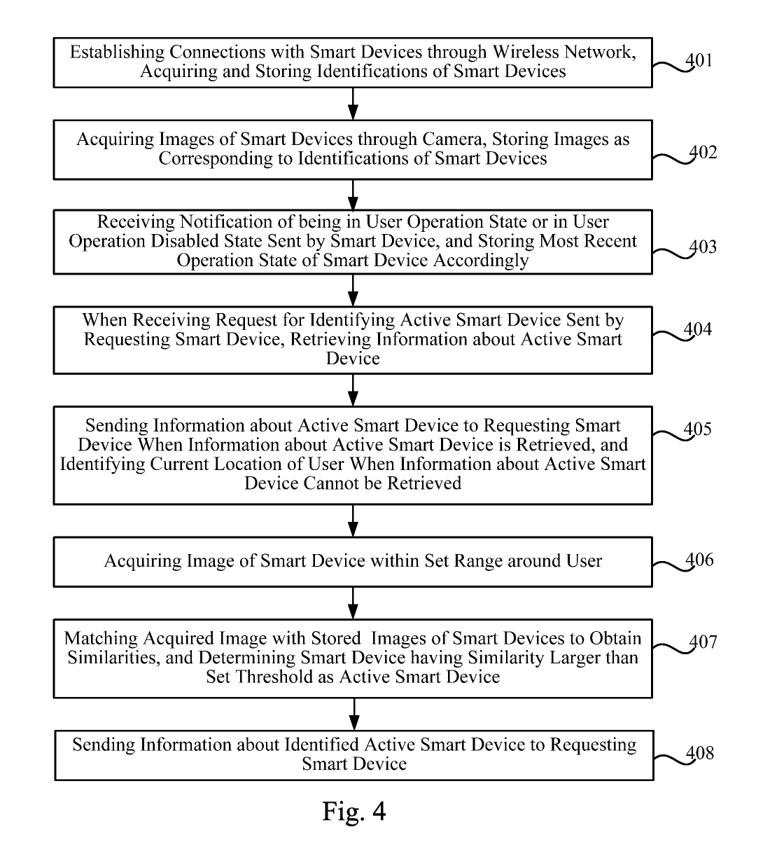

FIG. 4 is a flow chart illustrating a method for sending a message according to another exemplary embodiment, which can be implemented, for example, in a control device. As shown in FIG. 4, at 401, connections are established with smart devices through a wireless network, and identifications of the smart devices are acquired and stored. In some embodiments, the control device can be a router. The router can establish connections with the smart devices having wireless communication modules, such as a smart terminal, a wearable device, and a smart household appliance, and can store identifications of the connected smart devices.

At 402, images of the smart devices are acquired through a camera and are stored as corresponding to the identifications of the smart devices.

At 403, a notification sent by a smart device is received, and the most recent operation state of the smart device is stored according to the notification. The notification indicates the smart device is in a user operation state or in a user operation disabled state.

At 404, when a request for identifying an active smart device is received, information about the active smart device is retrieved. The request can be sent by a requesting smart device connected to the control device when receiving a message.

At 405, when the information about the active smart device is retrieved, the information is sent to the requesting smart device. On the other hand, when the information about the active smart device cannot be retrieved, a current location of a user is identified using an indoor positioning technique.

At 406, an image of a smart device that is within a set range around the user is acquired. The set range can be, for example, a range of a circular region having a radius of 1 meter and having the location of the user as a center. The camera can be a camera on the router or can be a camera on a smart device.

At 407, the acquired image is matched with the stored images of smart devices to obtain similarities, and the smart device having a similarity larger than a set threshold is determined as the active smart device. The stored images can be the images acquired at process 402. That is, even if the user is not currently operating the smart device having a similarity larger than the set threshold, such smart device can nonetheless be determined as the active smart device, since it is close to the user and thus can draw the user's attention.

At 408, the information about the active smart device is sent to the requesting smart device.

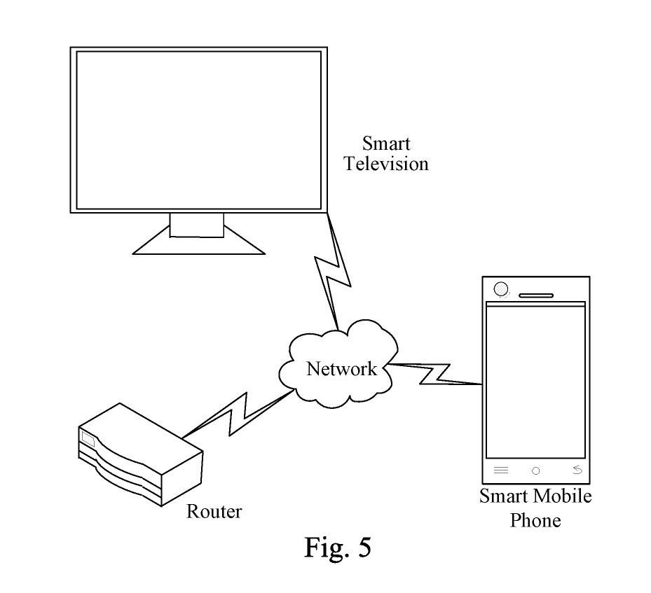

FIG. 5 is a schematic diagram illustrating an application scenario for sending a message according to an exemplary embodiment of the present disclosure. As shown in FIG. 5, the scenario includes a smart mobile phone as a smart device that receives the message, a router as a control device, and a smart television as an active smart device.

Smart devices including the smart mobile phone and the smart television are connected to the router in advance. Moreover, the router stores identifications of the smart devices connected with it. The smart devices send their operation states to the control device, and the control device stores the operation states as corresponding to the identifications. When the smart mobile phone receives a message, the smart mobile phone determines whether a touch operation occurs. If no touch operation is detected within a set time period, the smart mobile phone can determine that it is in the user operation disabled state.

In some embodiments, the smart mobile phone sends the received message to the router. The router queries the states of the smart devices and finds out that the smart television is in the user operation state. Then the router sends the received message to the smart television.

In some embodiments, a process of sending a message that is similar to one of the exemplary methods described above with reference to FIGS. 1-4 can be implemented in the application scenario of FIG. 5. Detailed description of such embodiments is omitted.

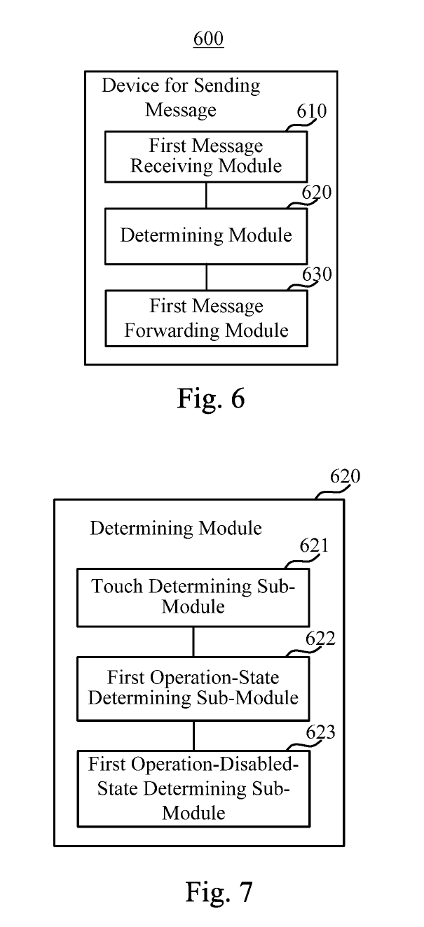

FIG. 6 is a block diagram of a device 600 for sending a message according to an exemplary embodiment of the present disclosure. The device 600 can be implemented, for example, in a smart device. As shown in FIG. 6, the device 600 includes a first message receiving module 610, a determining module 620, and a first message sending module 630. The first message receiving module 610 is configured to receive a message. The determining module 620 is configured to determine whether the smart device is in a user operation state. The first message sending module 630 is configured to identify another smart device that is in the user operation state when the determining module 620 determines that the smart device is not in the user operation state, and forward the message to the other smart device that is in the user operation state.

FIG. 7 is a block diagram of an example of the determining module 620 in the device 600. As shown in FIG. 7, the determining module 620 includes a touch determining sub-module 621, a first operation-state determining sub-module 622, and a first operation-disabled-state determining sub-module 623. The touch determining sub-module 621 is configured to determine whether a touch operation occurs. The first operation-state determining sub-module 622 is configured to determine that the smart device is in the user operation state when the touch determining sub-module 621 detects a touch operation. The first operation-disabled-state determining sub-module 623 is configured to determine that the smart device is in a user operation disabled state when the touch determining sub-module 621 does not detect a touch operation within a set time period or when the touch determining sub-module 621 detects a locked screen.

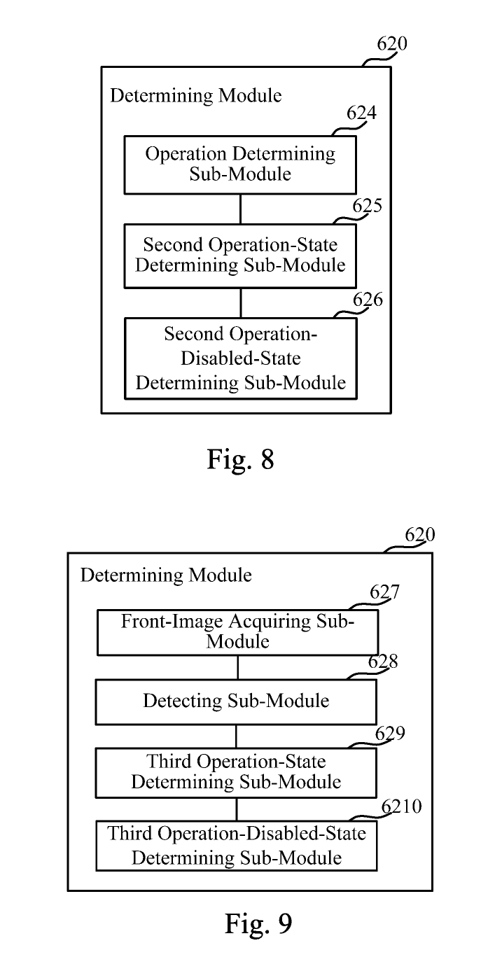

FIG. 8 is a block diagram of another example of the determining module 620. As shown in FIG. 8, the determining module 620 includes an operation determining sub-module 624, a second operation-state determining sub-module 625 and a second operation-disabled-state determining sub-module 626. The operation determining sub-module 624 is configured to determine whether a putting-on operation or a taking-off operation is detected. The second operation-state determining sub-module 625 is configured to determine that the smart device is in the user operation state when the operation determining sub-module 624 detects a putting-on operation. The second operation-disabled-state determining sub-module 626 is configured to determine that the smart device is in the user operation disabled state when the operation determining sub-module 624 detects a taking-off operation.

FIG. 9 is a block diagram of another example of the determining module 620. As shown in FIG. 9, the determining module 620 includes a front-image acquiring sub-module 627, a detecting sub-module 628, a third operation-state determining sub-module 629, and a third operation-disabled-state determining sub-module 6210. The front-image acquiring sub-module 627 is configured to acquire a front image through a front camera. The detecting sub-module 628 is configured to determine whether a user face image is detected in the front image using a face recognition technique. The third operation-state determining sub-module 629 is configured to determine that the smart device is in the user operation state when the user face image is detected. The third operation-disabled-state determining sub-module 6210 is configured to determine that the smart device is in the user operation disabled state when no user face image is detected in the front image.

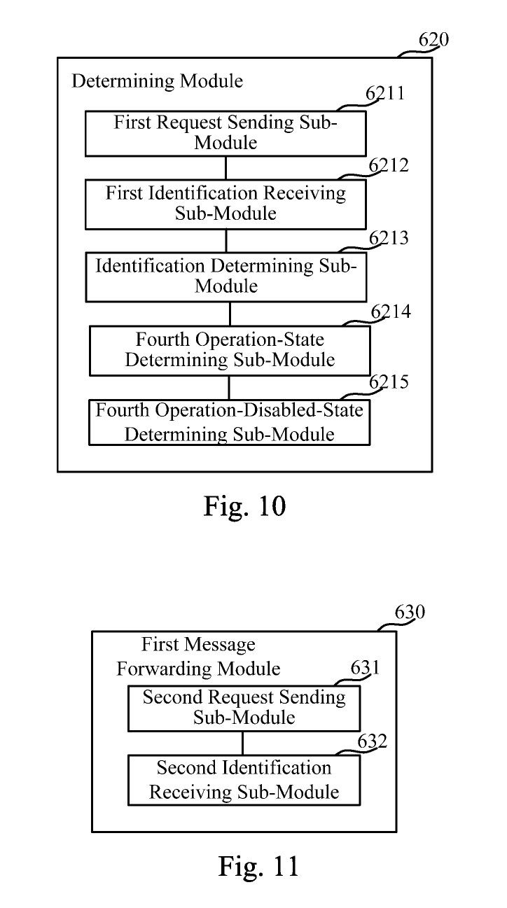

FIG. 10 is a block diagram of another example of the determining module 620. As shown in FIG. 10, the determining module 620 includes a first request sending sub-module 6211, a first identification receiving sub-module 6212, an identification determining sub-module 6213, a fourth operation-state determining sub-module 6214, and a fourth operation-disabled-state determining sub-module 6215. The first request sending sub-module 6211 is configured to send a request to a control device for acquiring a smart device that is in the user operation state when no current operation state is acquired. The control device is connected to smart devices for managing operation states of the smart devices. The first identification receiving sub-module 6212 is configured to receive from the control device an identification of a smart device that is in the user operation state. The identification determining sub-module 6213 is configured to determine whether the identification received by the first identification receiving sub-module 6212 corresponds to the identification of the smart device itself. The fourth operation-state determining sub-module 6214 is configured to determine that the smart device is in the user operation state when the identification determining sub-module 6213 determines that the received identification corresponds to the identification of the smart device itself. The fourth operation-disabled-state determining sub-module 6215 is configured to determine that the smart device is in the user operation disabled state when the identification determining sub-module 6213 determines that the received identification does not correspond to the identification of the smart device itself.

FIG. 11 is a block diagram of an example of the first message forwarding module 630 in the device 600. As shown in FIG. 11, the first message forwarding module 630 includes a second request sending sub-module 631 and a second identification receiving sub-module 632. The second request sending sub-module 631 is configured to send a request to the control device for acquiring another smart device that is in the user operation state. The second identification receiving sub-module 632 is configured to receive from the control device an identification of the other smart device that is in the user operation state.

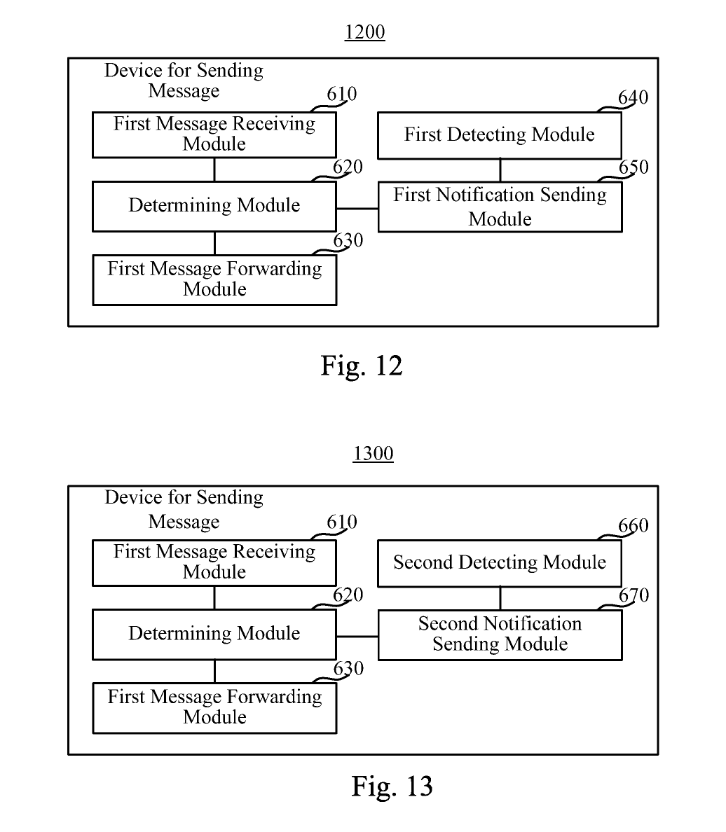

FIG. 12 is a block diagram of a device 1200 for sending a message according to another exemplary embodiment of the present disclosure. As shown in FIG. 12, the device 1200 includes the first message receiving module 610, the determining module 620, the first message forwarding module 630, a first detecting module 640, and a first notification sending module 650.

The first detecting module 640 is configured to detect whether the smart device itself is in the user operation state. The first notification sending module 650 is configured to send to the control device a notification of being in the user operation state when the first detecting module 640 detects that the smart device is in the user operation state. Thus, the smart device can timely report to the control device when the smart device is in the user operation state, for the control device to timely update the stored state of the smart device. The notification carries the identification of the smart device such that the control device marks a stored state corresponding to the identification as being in the user operation state.

In some embodiments, the first detecting module 640 determines that the smart device is in the user operation state if it detects a touch operation or a putting-on operation, or detects a user face image in a front image captured by a front camera using a face recognition technique.

FIG. 13 is a block diagram of a device 1300 for sending a message according to another exemplary embodiment of the present disclosure. As shown in FIG. 13, the device 1300 includes the first message receiving module 610, the determining module 620, the first message forwarding module 630, a second detecting module 660, and a second notification sending module 670.

The second detecting module 660 is configured to detect whether the smart device itself is in the user operation state. The second notification sending module 670 is configured to send to the control device a notification of being in the user operation disabled state when the second detecting module 660 detects that the smart device is in the user operation disabled state.

In some embodiments, the second detecting module 660 determines that the smart device is in the user operation disabled state if it does not detect a touch operation within a preset time period, detects a locked screen, detects a taking-off operation, or does not detect a user face image in a front image captured by a front camera using a face recognition technique within a preset time period.

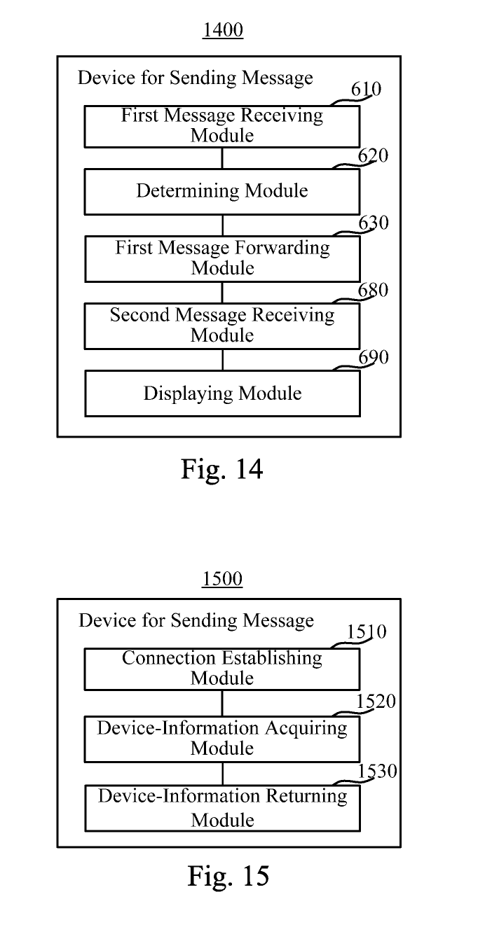

FIG. 14 is a block diagram of a device 1400 for sending a message according to another exemplary embodiment of the present disclosure. As shown in FIG. 14, the device 1400 includes the first message receiving module 610, the determining module 620, the first message forwarding module 630, a second message receiving module 680, and a displaying module 690.

The second message receiving module 680 is configured to receive the message forwarded by the control device from another smart device receiving the message. The displaying module 690 is configured to display the message received by the second message receiving module 680. In some embodiments, the displaying module 690 is configured to display the message on a screen or lenses.

The exemplary devices for sending a message described above with reference to FIGS. 6-14 can be implemented, for example, in a smart device.

FIG. 15 is a block diagram of a device 1500 for sending a message according to another exemplary embodiment of the present disclosure. The device 600 can be implemented, for example, in a control device. As shown in FIG. 15, the device 1500 includes a connection establishing module 1510, a device-information acquiring module 1520, and a device-information returning module 1530. The connection establishing module 1510 is configured to establish connections with smart devices. The device-information acquiring module 1520 is configured to acquire information about an active smart device when a request for identifying active smart device is received. The device-information returning module 1530 is configured to return the information about the active smart device acquired by the device-information acquiring module 1520.

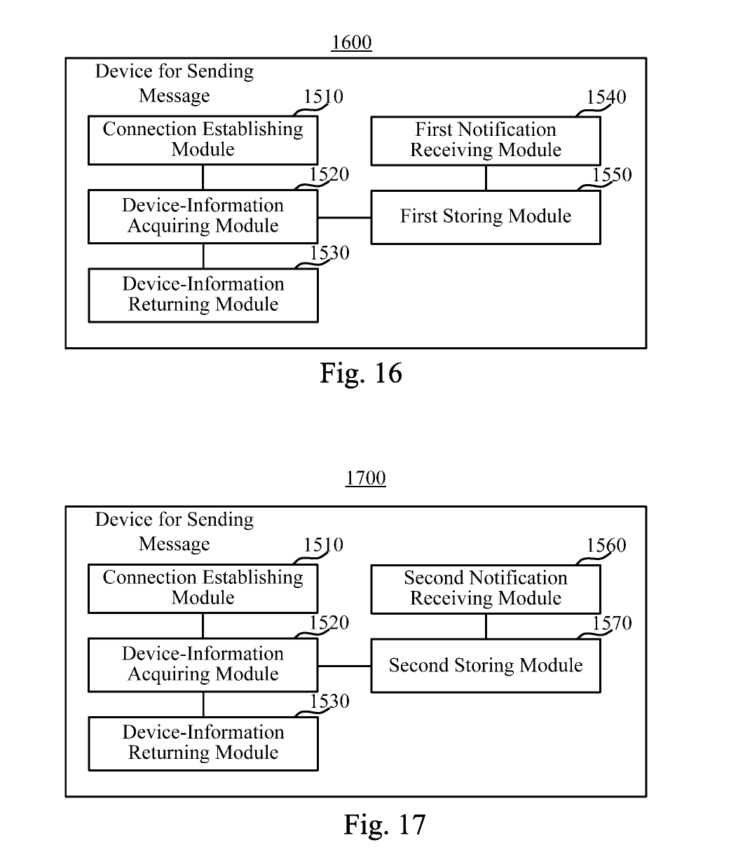

FIG. 16 is a block diagram of a device 1600 for sending a message according to another exemplary embodiment of the present disclosure. As shown in FIG. 16, the device 1600 includes the connection establishing module 1510, the device-information acquiring module 1520, the device-information returning module 1530, a first notification receiving module 1540, and a first storing module 1550.

The first notification receiving module 1540 is configured to receive a notification of being in the user operation state sent by a smart device. The first storing module 1550 is configured to store a most recent operation state of the smart device according to the notification received by the first notification receiving module 1540.

FIG. 17 is a block diagram of a device 1700 for sending a message according to another exemplary embodiment of the present disclosure. As shown in FIG. 17, the device 1700 includes the connection establishing module 1510, the device-information acquiring module 1520, the device-information returning module 1530, a second notification receiving module 1560, and a second storing module 1570.

The second notification receiving module 1560 is configured to receive a notification of being in the user operation disabled state sent by a smart device. The second storing module 1570 is configured to store a most recent operation state of the smart device according to the notification received by the second notification receiving module 1560.

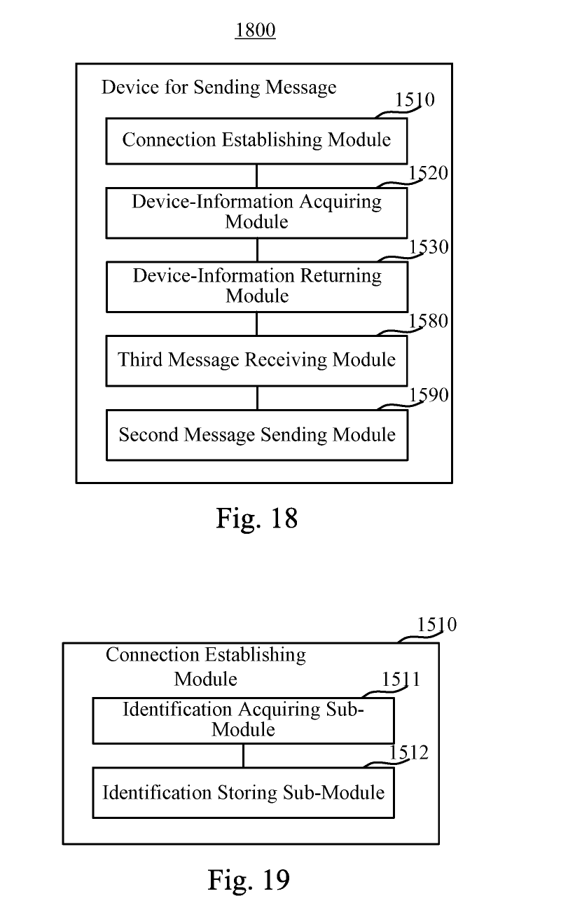

FIG. 18 is a block diagram of a device 1800 for sending a message according to another exemplary embodiment of the present disclosure. As shown in FIG. 18, the device 1800 includes the connection establishing module 1510, the device-information acquiring module 1520, the device-information returning module 1530, a third message receiving module 1580, and a second message forwarding module 1590.

The third message receiving module 1580 is configured to receive from a smart device a message newly received by the smart device. The second message forwarding module 1590 is configured to forward the message received by the third message receiving module 1580 to an active smart device. In some embodiments, information about the active smart device is retrieved by the device-information acquiring module 1520, and the second message forwarding module 1590 forwards the message according to the information retrieved by the device-information acquiring module 1520.

FIG. 19 is a block diagram of an example of the connection establishing module 1510 in the device 1500, 1600, 1700, or 1800. As shown in FIG. 19, the connection establishing module 1510 includes an identification acquiring sub-module 1511 and an identification storing sub-module 1512. The identification acquiring sub-module 1511 is configured to acquire identifications of smart devices connected to the control device. The identification storing sub-module 1512 is configured to store the identifications received by the identification acquiring sub-module 1511.

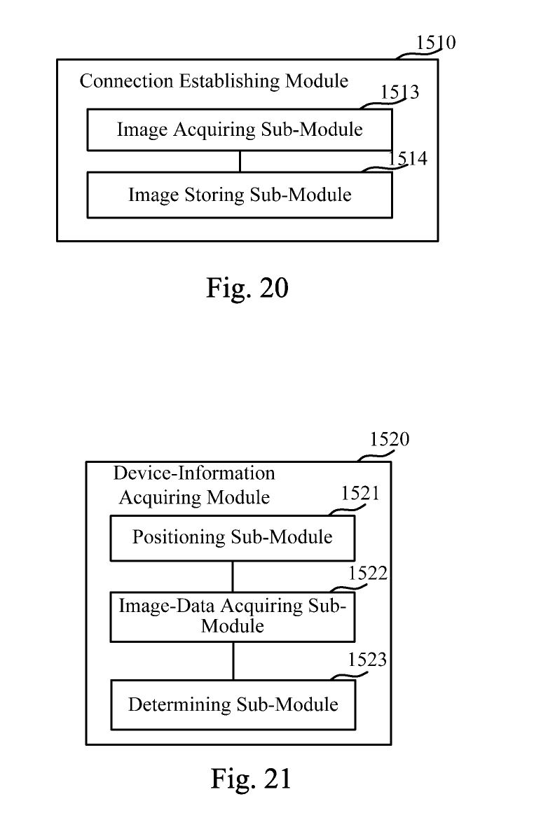

FIG. 20 is a block diagram of another example of the connection establishing module 1510. As shown in FIG. 20, the connection establishing module 1510 includes an image acquiring sub-module 1513 and an image storing sub-module 1514. The image acquiring sub-module 1513 is configured to acquire an image of a smart device when a connection with the smart device is established. The image storing sub-module 1514 is configured to store the image acquired by the image acquiring sub-module 1513 as corresponding to an identification of the smart device. In some embodiments, the image acquiring sub-module 1513 captures the image of the smart device through a camera.

FIG. 21 is a block diagram of an example of the device-information acquiring module 1520 in the device 1500. As shown in FIG. 21, the device-information acquiring module 1520 includes a positioning sub-module 1521, an image-data acquiring sub-module 1522, and a determining sub-module 1523. The positioning sub-module 1521 is configured to identify a current location of a user using an indoor positioning technique when the device-information acquiring module 1520 cannot retrieve information about an active smart device. The image-data acquiring sub-module 1522 is configured to acquire an image of a smart device that is within a set range around the user identified by the positioning sub-module 1521. The determining sub-module 1523 is configured to match the image acquired by the image-data acquiring sub-module 1522 with stored images of smart devices to obtain similarities and determine the smart device having a similarity larger than a set threshold as the active smart device. In some embodiments, the image-data acquiring sub-module 1522 captures the image through a camera.

The exemplary devices for sending a message described above with reference to FIGS. 15-21 can be implemented, for example, in a router.

Operations of the above-described exemplary devices are similar to the exemplary methods described above, and thus their detailed description is omitted here. The exemplary devices described above are merely illustrative. The units described as separate may be or may not be physically separate, and the components illustrated as units may be or may not be physical units, and may be at the same location, or may be distributed to multiple units over the network. A part of or the whole of the modules can be selected to achieve the objective of the present disclosure as desired. One skilled in the art can understand and practice the embodiments without labor.

The present disclosure also provides a terminal including a processor and a memory storing instructions executable by the processor. The processor is configured to perform a method consistent with the present disclosure, such as one of the above-described exemplary methods.

The present disclosure also provides a router including a processor and a memory storing instructions executable by the processor. The processor is configured to perform a method consistent with the present disclosure, such as one of the above-described exemplary methods.

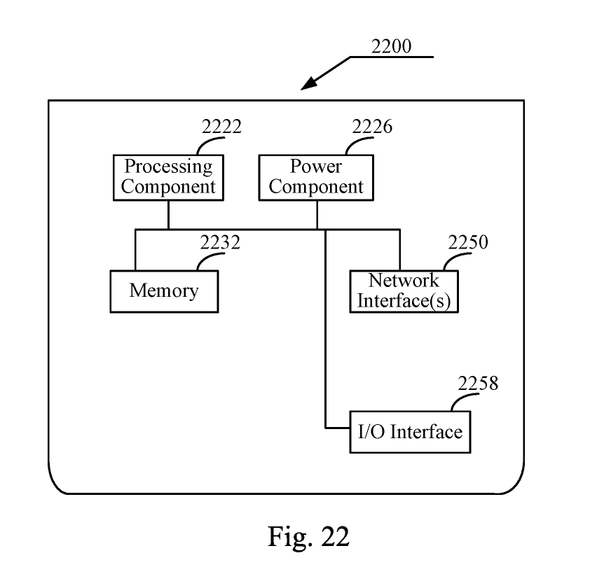

FIG. 22 is a block diagram of a device 2200 for sending a message according to another exemplary embodiment. For example, the device 2200 can be provided as a router. Referring to FIG. 22, the device 2200 includes a processing component 2222 that further includes one or more processors, and memory resources represented by a memory 2232 for storing instructions executable by the processing component 2222, such as application programs. The application programs stored in the memory 2232 may include one or more modules each corresponding to a set of instructions. Further, the processing component 2222 is configured to execute the instructions to perform a method for sending a message consistent with the present disclosure, such as one of the above-described exemplary methods.

The device 2200 also includes a power component 2226 configured to perform power management of the device 2200, wired or wireless network interface(s) 2250 configured to connect the device 2200 to a network, and an input/output (I/O) interface 2258. The device 2200 may operate based on an operating system stored in the memory 2232, such as Windows Server™, Mac OS X™, Unix™, Linux™, FreeBSD™, or the like.

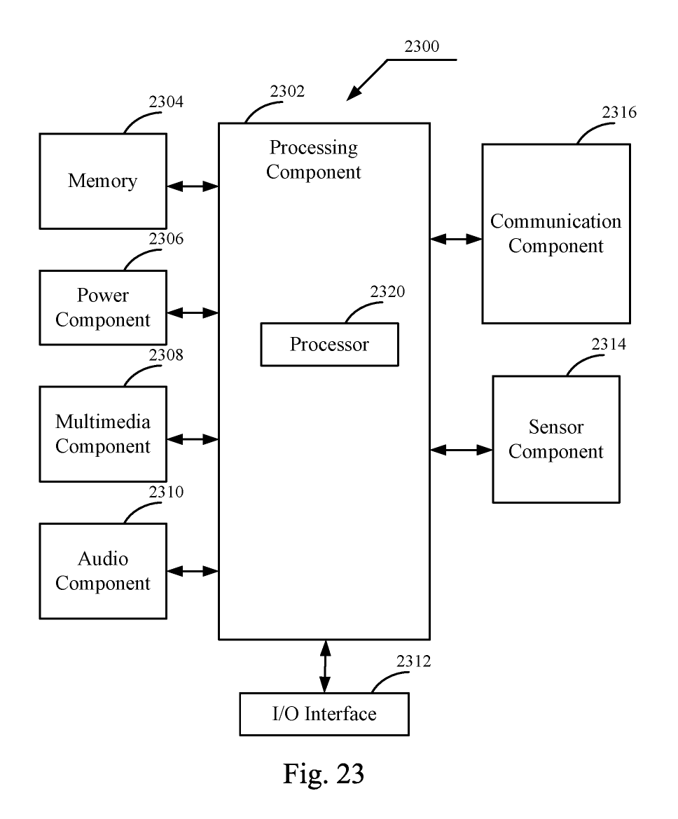

FIG. 23 is a block diagram of a device 2300 for sending a message according to an exemplary embodiment. The device 2300 can be, for example, a mobile phone, a computer, a digital broadcast terminal, a messaging device, a gaming console, a tablet, a medical device, exercise equipment, a personal digital assistant, or the like.

Referring to FIG. 23, the device 2300 includes one or more of the following components a processing component 2302, a memory 2304, a power component 2306, a multimedia component 2308, an audio component 2310, an input/output (I/O) interface 2312, a sensor component 2314, and a communication component 2316.

The processing component 2302 typically controls overall operations of the device 2300, such as the operations associated with display, telephone calls, data communications, camera operations, and recording operations. The processing component 2302 can include one or more processors 2320 to execute instructions to perform all or part of a method consistent with the present disclosure, such as one of the above-described exemplary methods. Moreover, the processing component 2302 can include one or more modules which facilitate the interaction between the processing component 2302 and other components. For example, the processing component 2302 can include a multimedia module to facilitate the interaction between the multimedia component 2308 and the processing component 2302.

The memory 2304 is configured to store various types of data to support the operation of the device 2300. Examples of such data include instructions for any applications or methods operated on the device 2300, contact data, phonebook data, messages, pictures, video, etc. The memory 2304 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2306 provides power to various components of the device 2300. The power component 2306 can include a power management system, one or more power sources, and any other components associated with the generation, management, and distribution of power in the device 2300.

The multimedia component 2308 includes a screen providing an output interface between the device 2300 and the user. In some embodiments, the screen can include a liquid crystal display (LCD) and a touch panel. If the screen includes the touch panel, the screen can be implemented as a touch screen to receive input signals from the user. The touch panel includes one or more touch sensors to sense touches, swipes, and gestures on the touch panel. The touch sensors not only senses a boundary of a touch or swipe action, but also senses a period of time and a pressure associated with the touch or swipe action. In some embodiments, the multimedia component 2308 includes a front camera and/or a rear camera. The front camera and the rear camera can receive an external multimedia datum while the device 2300 is in an operation mode, such as a photographing mode or a video mode. Each of the front camera and the rear camera can be a fixed optical lens system or have focus and optical zoom capability.

The audio component 2310 is configured to output and/or input audio signals. For example, the audio component 2310 includes a microphone configured to receive an external audio signal when the device 2300 is in an operation mode, such as a call mode, a recording mode, and a voice recognition mode. The received audio signal can be further stored in the memory 2304 or transmitted via the communication component 2316. In some embodiments, the audio component 2310 further includes a speaker to output audio signals.

The I/O interface 2312 provides an interface between the processing component 2302 and peripheral interface modules, such as a keyboard, a click wheel, buttons, and the like. The buttons can include, but are not limited to, a home button, a volume button, a starting button, and a locking button.

The sensor component 2314 includes one or more sensors to provide status assessments of various aspects of the device 2300. For example, the sensor component 2314 can detect an open/closed status of the device 2300, relative positioning of components, e.g., the display and the keypad, of the device 2300, a change in position of the device 2300 or a component of the device 2300, a presence or absence of user contact with the device 2300, an orientation or an acceleration/deceleration of the device 2300, and a change in temperature of the device 2300. The sensor component 2314 can include a proximity sensor configured to detect the presence of nearby objects without any physical contact. The sensor component 2314 can also include a light sensor, such as a CMOS or CCD image sensor, for use in imaging applications. In some embodiments, the sensor component 2314 can also include an accelerometer sensor, a gyroscope sensor, a magnetic sensor, a pressure sensor, a microwave sensor or a temperature sensor.

The communication component 2316 is configured to facilitate communication, wired or wirelessly, between the device 2300 and other devices. The device 2300 can access a wireless network based on a communication standard, such as WiFi, 2G, 3G, 4G or a combination thereof. In one exemplary embodiment, the communication component 2316 receives a broadcast signal or broadcast associated information from an external broadcast management system via a broadcast channel. In one exemplary embodiment, the communication component 2316 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth technology, and another technology.

In exemplary embodiments, the device 2300 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 2304, executable by the processor 2320 in the device 2300, for performing a method consistent with the present disclosure, such as one of the above-described exemplary methods. For example, the computer-readable storage medium can be a ROM, a RAM, a CD-ROM, a magnetic tape, a floppy disc, an optical data storage device, or the like.

The present disclosure provides a non-transitory computer readable storage medium storing instructions that, when executed by the processor of a mobile terminal, cause the mobile terminal to perform a method for sending a message consistent with the present disclosure, such as one of the above-described exemplary methods.

The present disclosure provides a non-transitory computer readable storage medium storing instructions that, when executed by the processor of a router, cause the router to perform a method for sending a message consistent with the present disclosure, such as one of the above-described exemplary methods.

According to the present disclosure, when a smart device not in the user operation state receives a message, the smart device forwards the received message to a smart device in the user operation state, so as to timely notify the user of receiving a new message. As such, the user can timely check the new message, and thus avoid missing important messages. This brings convenience to the user and improves user experience.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for sending a message, comprising:
receiving the message by a first smart device;
determining whether the first smart device is in a user operation state; and
if the first smart device is not in the user operation state, identifying a second smart device that is in the user operation state, and forwarding the message to the second smart device.

2. The method of claim 1, wherein determining whether the first smart device is in the user operation state includes:
determining whether a touch operation on the first smart device occurs;
determining, if the touch operation occurs, that the first smart device is in the user operation state; and
determining, if no touch operation is detected within a set time period or if a locked screen is detected, that the first smart device is not in the user operation state.

3. The method of claim 1, wherein determining whether the first smart device is in the user operation state includes:
determining whether a putting-on operation or a taking-off operation of the first smart device is detected;
determining, if the putting-on operation is detected, that the first smart device is in the user operation state; and
determining, if the taking-off operation is detected, that the first smart device is not in the user operation state.

4. The method of claim 1, wherein determining whether the first smart device is in the user operation state includes:
acquiring an image through a camera on the first smart device;
determining whether the image contains a face using a face recognition technique;
determining, if the image contains a face, that the first smart device is in the user operation state; and
determining, if the image does not contain a face, that the first smart device is not in the user operation state.

5. The method of claim 1, wherein determining whether the first smart device is in the user operation state includes:
sending a request to a control device for acquiring a smart device in the user operation state;
receiving from the control device an identification of the smart device in the user operation state;
determining whether the received identification corresponds to an identification of the first smart device;
determining, if the received identification corresponds to the identification of the first smart device, that the first smart device is in the user operation state; and
determining, if the received identification does not correspond to the identification of the first smart device, that the first smart device is not in the user operation state.

6. The method of claim 1, wherein identifying the second smart device includes:
sending a request to a control device for acquiring the second smart device; and
receiving from the control device an identification of the second smart device.

7. The method of claim 1, further comprising:
detecting that the first smart device is in the user operation state; and
sending to a control device a notification indicating that the first smart device is in the user operation state.

8. The method of claim 7, wherein sending to the control device the notification includes:
sending to the control device the notification carrying an identification of the first smart device.

9. The method of claim 7, wherein detecting that the first smart device is in the user operation state includes detecting a touch operation, detecting a putting-on operation, or detecting a face in an image captured by a camera on the first smart device.

10. The method of claim 1, further comprising:
detecting that the first smart device is not in the user operation state; and
sending to a control device a notification indicating that the first smart device is not in the user operation state.

11. The method of claim 10, wherein detecting that the first smart device is not in the user operation state includes detecting no touch operation within a first preset time period, detecting a locked screen, detecting a taking-off operation, or detecting no user face in an image captured by a camera on the first smart device within a second preset time period.

12. The method of claim 1,
wherein the message is a first message,
the method further comprising:
receiving a second message forwarded by a control device; and
displaying the second message.

13. A method for sending a message, comprising:
establishing connections with smart devices;
receiving a request from a requesting smart device for identifying an active smart device that is in a user operation state;
acquiring information about the active smart device; and
returning the information to the requesting smart device.

14. The method of claim 13, further comprising:
receiving a notification sent by one of the smart devices indicating the one of the smart devices is in the user operation state; and
storing a most recent operation state of the one of the smart devices according to the notification.

15. The method of claim 13, further comprising:
receiving a notification sent by one of the smart devices indicating the one of the smart devices is not in the user operation state; and
storing a most recent operation state of the one of the smart devices according to the notification.

16. The method of claim 13, further comprising:
receiving the message from the requesting smart device; and
forwarding the message to the active smart device.

17. The method of claim 13, wherein establishing the connections includes:
acquiring identifications of the smart devices; and
storing the identifications of the smart devices.

18. The method of claim 13, wherein establishing the connections includes:
acquiring images of the smart devices; and
storing the images as corresponding to identifications of the smart devices.

19. The method of claim 18, wherein acquiring the information about the active smart device includes:
identifying a current location of a user using an indoor positioning technique;
acquiring an image of a smart device that is within a set range around the user; and
matching the acquired image with the stored images of the smart devices to obtain similarities, to identify one of the smart devices that has a similarity larger than a set threshold as the active smart device.

20. A terminal, comprising:
a processor; and
a memory storing instructions that, when executed by the processor, cause the processor to:
receive a message;
determine whether the terminal is in a user operation state; and
if the terminal is not in the user operation state, identify another terminal that is in the user operation state, and forward the message to the other terminal.

21. A router, comprising:
a processor; and
a memory storing instructions that, when executed by the processor, cause the processor to:
establish connections with smart devices;
receive a request from a requesting smart device for identifying an active smart device that is in a user operation state;
acquire information about the active smart device; and
return the information to the requesting smart device.
